(19) United States
(12) Patent Application Publication
(10) Pub. No.: US 2002/0092338 A1
(43) Pub. Date: Jul. 18, 2002

(54) General motor calibration and torque calibration cartridge

(76) Inventors: Michael V. Andersen, Layton, UT (US); S. Dennis Evans, Fruit Heights, UT (US); Michael J. Scoresby, Ogden, UT (US); Wayne A. Sumner, Ogden, UT (US); Charles Hudson, Ogden, UT (US)

Correspondence Address: Woodcock Washburn Kurtz, Mackiewicz & Norris LLP, 46th Floor, One Liberty Place, Philadelphia, PA, 19103, US

(21) Appl. No.: 09/760,174

(22) Filed: Jan. 15, 2001

(51) Int. Cl. G01G 19/56; G01G 23/01

(52) U.S. Cl. 73/1.11; 73/1.08; 324/202; 324/210

(57) ABSTRACT

A device for calibrating drag test drives comprises a disk drive unit, a non conductive, non magnetic disk, and a magnet placed substantially planar to the non magnetic disk wherein the disk can spin in the disk drive through a magnetic field produced by the magnet. The device also comprises a current measuring device wherein the device measures the amount of current the disk drive motor draws while spinning the disk.

### BACKGROUND OF THE INVENTION

1. Field of the Invention

The present invention relates generally to data storage devices and more particularly to apparatus and methods for calibrating a drag measuring disk drive unit.

2. Description of the Art

Removable storage media and disk drive units are well known in the computer field. U.S. Pat. No. 5,650,891 shows an exemplary data storage device or disk drive commonly referred to as a Zip™ drive. FIG. 1 is a perspective view of such a device. As shown, the disk drive 40 comprises an outer housing 42 having top and bottom covers 44, 46 and a front panel 48. A disk cartridge such as that shown in FIG. 3 can be inserted into the disk drive 40 through an opening 51 in the front panel 48 of the disk drive 40. An eject button 53 is also provided on the front panel for automatically ejecting a disk cartridge from the disk drive 40. The disk drive 40 can be employed as a stand-alone unit, or alternatively, can be employed as an internal disk drive of a computer (not shown).

FIG. 2 is a top view of the disk drive 40 of FIG. 1 with the top cover 44 removed. The disk drive 40 comprises an internal platform 50 that slides along opposing side rails 52, 54 between a forward position and a rearward position. A pair of springs 56, 58 bias the platform 50 toward its forward position. An actuator is mounted to the rear of the platform 50. The linear actuator comprises a carriage assembly 62 having two lightweight flexible arms 64, 66. The recording heads 18, 19 of the disk drive are mounted at the ends of the respective arms 64, 66. A coil 68, which is part of a voice coil motor, is mounted at the opposite end of the carriage 62. The coil 68 interacts with magnets (not shown) to move the carriage linearly so that the heads 18 and 19 can move radially over respective recording surfaces of a disk cartridge inserted into the disk drive.

The disk drive 40 further comprises a spindle motor 82 capable of rotating the recording medium of a disk cartridge at a predetermined operating speed. As described hereinafter, when a disk cartridge is inserted into the disk drive, the hub of the disk cartridge engages the spindle motor 82 of the disk drive 40 when the platform reaches its rearward position.

FIG. 3 shows an exemplary disk cartridge 10 adapted for use in the disk drive 40 of FIG. 1. As shown, the disk cartridge 10 comprises an outer casing 12 having upper and lower shells 22, 24 that mate to form the casing. A disk-shaped recording medium (not shown) is affixed to a hub that is rotatably mounted in the casing 12. An opening on the bottom shell 24 of the casing 12 provides access to the disk hub. A head access opening 30 in the front peripheral edge 20 of the disk cartridge 10 provides access to the recording surfaces of the disk (not shown) by the recording heads of the disk drive. A shutter (not shown in FIG. 3) is provided on the front peripheral edge 20 of the disk cartridge 10 to cover the head access opening 30 when the cartridge is not in use. When the cartridge is inserted into the disk drive, the shutter moves to the side exposing the head access opening 30 and thereby providing the heads of the drive with access to the recording surface of the disk (not shown).

To reduce the risk of read/write error, removable disk cartridges have been developed that include a fuzzed liner. U.S. Pat. No. 5,677,818 describes a fuzzed liner and method for making the liner. The process of fuzzing the liner is called fluffing. The fluffing process involves brushing the liner of a disk cartridge until a certain amount of bonded fibers are loosened to form a region of upstanding fibers that extend from the main body of the cartridge to the surface of the disk. The upstanding fibers, which constitute the fuzzed liner, brush over the surface of the disk and wipe away unwanted particles that interrupt the read/write process.

FIG. 4 is a perspective view of a conventional fabric liner affixed to the inner surface of the lower shell 24 of the cartridge of FIG. 3 and illustrates a fuzzed region 28b of the liner.

In the fluffing process, a certain amount of fibers are fluffed. Too many fluffed fibers cause excess brushing which could lead to damage of the disk surface and causes excessive drag on the motor spindle. Not enough fluffed fibers are inadequate for proper cleaning of the disk surface. Therefore, it is critical to accurately determine how much drag is induced on the motor spindle by the fluffed fibers. The physical size of the fibers makes it extremely difficult to count the fibers. Therefore, in order to measure the amount of upstanding or fluffed fiber, the amount of drag induced on the drive motor by the fuzzed liner is used as an indication.

Consistently determining the amount of drag the fuzzed liner creates is an important task. One conventional way of determining the drag is to measure the amount of current a disk drive motor spindle unit draws while spinning a disk minus the amount of current the same disk drive motor spindle unit draws spinning without a disk. There are, however, several drawbacks to this technique. One drawback is the temperature and humidity around the spinning disk change. These physical changes create inconsistent drag readings that vary according to friction, temperature and humidity rather than the amount of upstanding fibers. These inconsistent readings make it difficult to determine the induced drag on the drive motor spindle.

Therefore, a need exists for a device to non-frictionally calibrate a disk drive unit that consistently measures the drag produced by the fluffed fibers in a disk drive cartridge and method of the same in a manner that overcomes the aforementioned disadvantages.

### SUMMARY OF THE INVENTION

The present invention enables the non-frictional calibration of a drag measuring disk drive. One aspect of the invention measures the magnetic properties of a calibration disk cartridge rather than the physical properties. More specifically, an exemplary embodiment of the invention measures the amount of current drawn by a disk drive motor spinning a calibration drag cartridge through a magnetic field. The amount of current drawn can then be compared to the amount of current a disk with a fluffed liner draws while spinning in the same drive. The comparison can be used to adjust the fluffing process.

An exemplary device for calibrating drag measuring disk drives in accordance with the present invention comprises a disk drive unit, a conductive, non magnetic disk and a magnet placed substantially planar to the non magnetic disk wherein the disk can spin in the disk drive through a magnetic field produced by the magnet. The device also comprises a current measuring device wherein the current measuring device measures the amount of current the disk drive motor draws while spinning the disk. The present invention also encompasses methods of using a disk cartridge to calibrate a drag drive.

### BRIEF DESCRIPTION OF THE DRAWINGS

The foregoing summary, as well as the following detailed description of the preferred embodiments, is better understood when read in conjunction with the attached drawings. For the purpose of illustrating the invention, there is shown in the drawings embodiments that are presently preferred, it being understood, however, that the invention is not limited to the specific apparatus, system, and instrumentalities disclosed. In the drawings:

FIG. 1 is a perspective view of an exemplary conventional data storage device or disk drive;

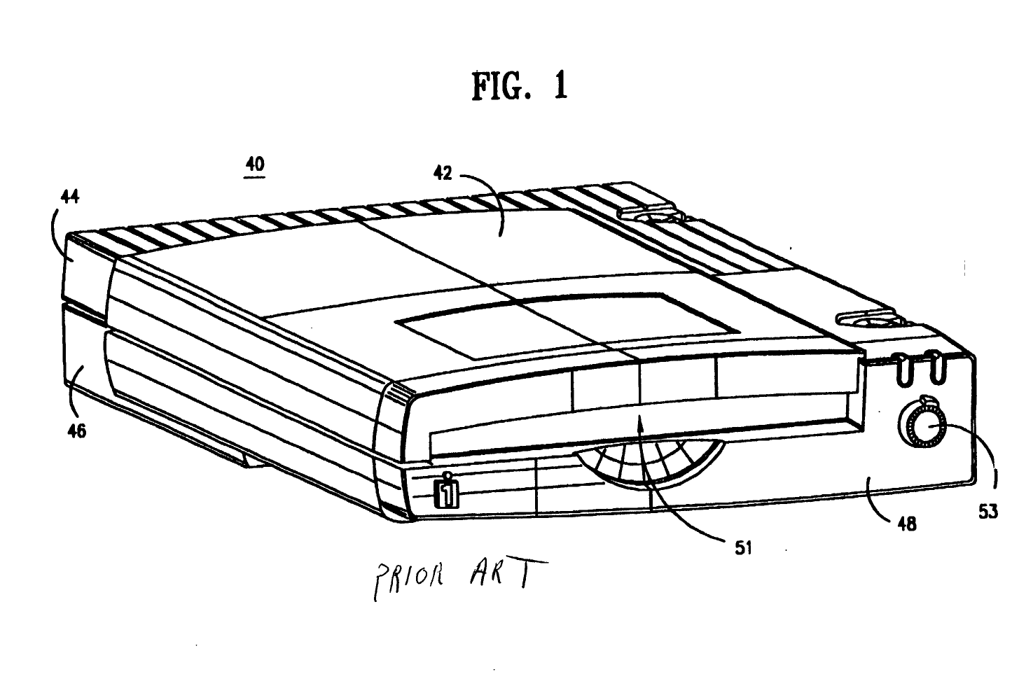

FIG. 2 is a top view of the conventional data storage device of FIG. 1 with a top cover of the device housing removed;

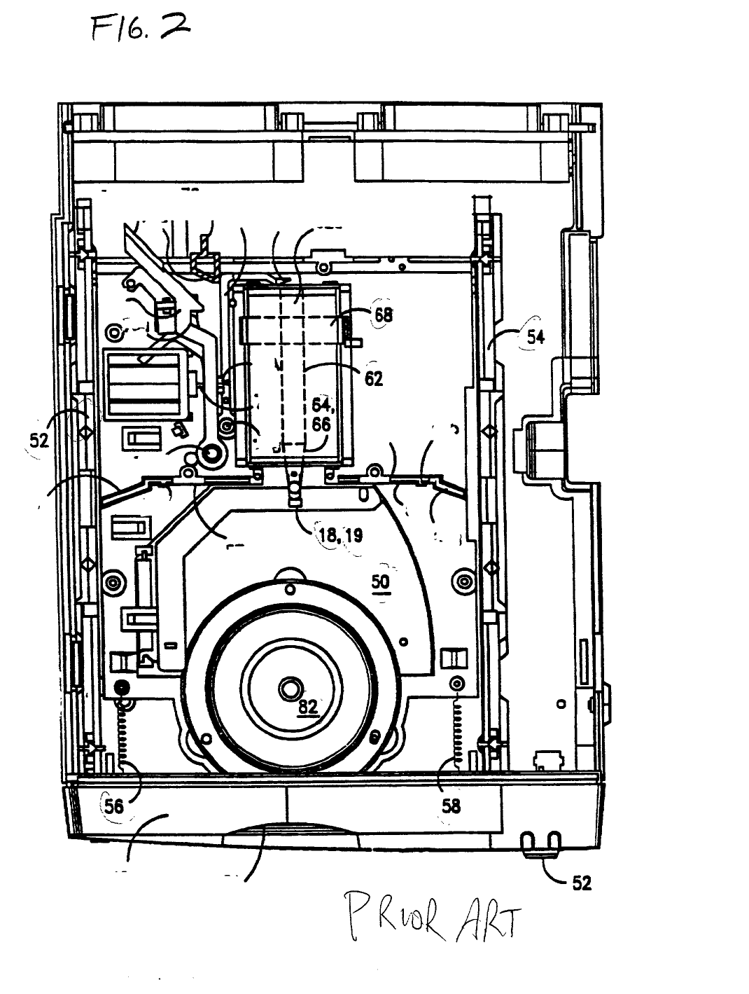

FIG. 3 is a perspective view of an exemplary conventional disk cartridge for use with the disk drive device of the FIG. 1;

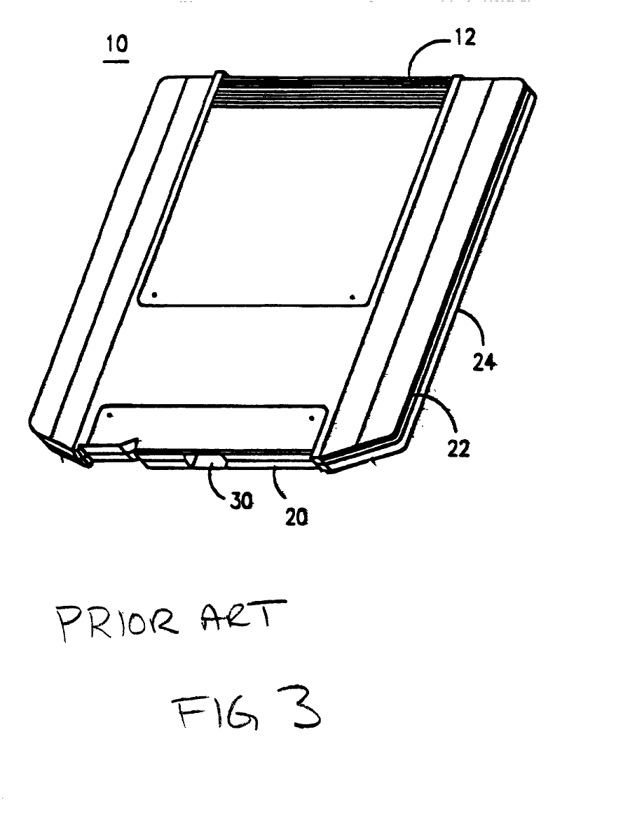

FIG. 4 is a perspective view of a conventional fabric liner affixed to the inner surface of the lower shell of the cartridge of FIG. 3 and illustrates a fuzzed region of the liner;

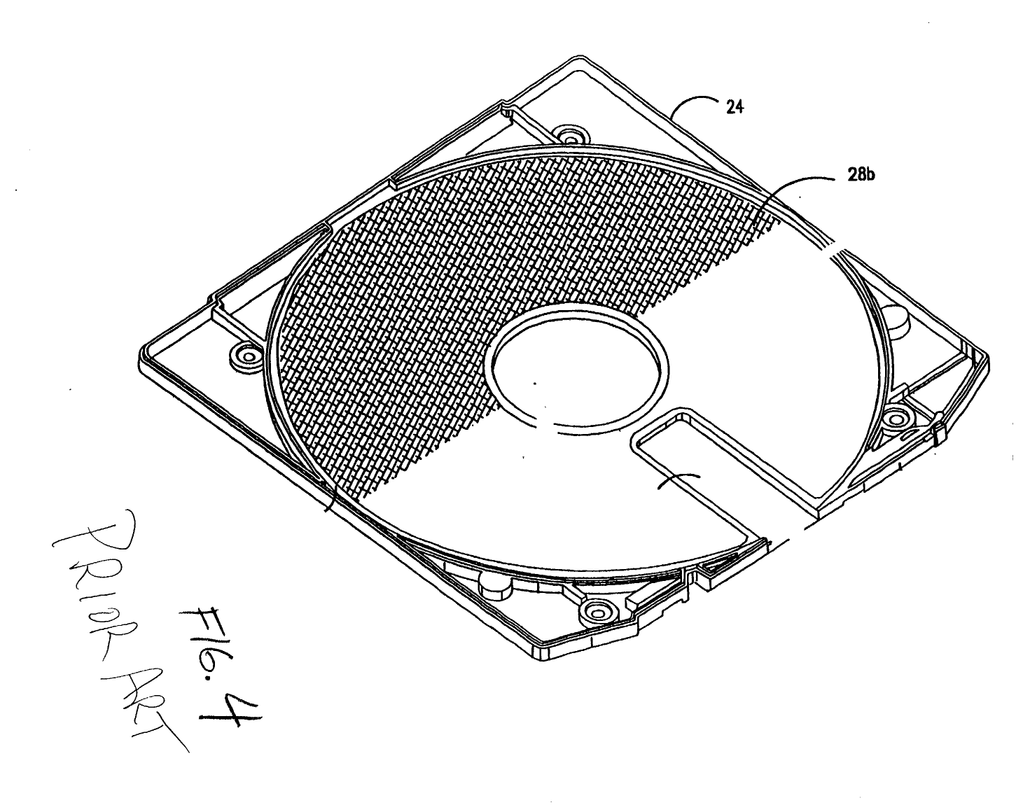

FIG. 5 is a perspective view of an exemplary calibration disk cartridge in which the invention is embodied;

FIG. 6 shows a top view of an exemplary calibration cartridge according to the principles of the invention;

FIG. 7 is side view of the disk cartridge of FIG. 5 according to the principles of the invention;

FIG. 8 is a diagram illustrating an apparatus for calibrating a drag measuring disk drive according to the invention;

FIG. 9 is a flowchart describing an exemplary method of determining the fluffed region of a disk cartridge according to the present invention; and

FIG. 10 is an exemplary power consumption curve in accordance with the invention.

### DETAILED DESCRIPTION

The invention relates to both methods and devices for measuring the amount of fluffed liner in a data storage cartridge such as a disk cartridge. The fluffing process is disclosed in U.S. Pat. No. 5,677,818 assigned to common assignee Iomega Corp., Roy, Utah and incorporated herein by reference in its entirety. Measuring the drag of a spinning cartridge determines the amount of fluffed fiber on the disk liner. The amount of fluff or upstanding fibers on the liner is directly proportional to the amount of drag that is produced, i.e., too much fluffed liner produces high drag and not enough fluffed liner produces low drag.

An exemplary device according to the principles of the invention for calibrating a drag measuring disk drive comprises a disk drive unit, a conductive, non magnetic disk, and a magnet placed substantially planar to the non magnetic disk. The disk can spin in the disk drive through a magnetic field produced by the magnet. The device also includes a current measuring device wherein the current measuring device measures the amount of current drawn by the disk drive motor while spinning the conductive, non magnetic disk.

In one embodiment, the present invention is embodied in a ZIP™ drive developed by Iomega Corporation, Roy, Utah. Many other disk drives units can be used without departing from the principles of the present invention.

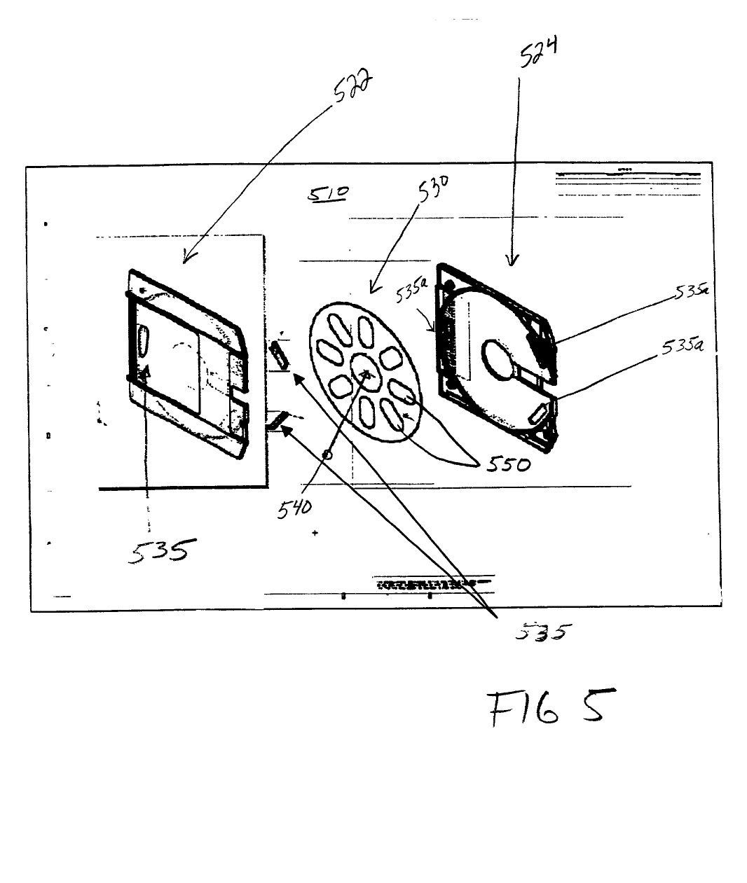

FIG. 5 is a perspective view of a disk cartridge 510 according to the principles of the present invention. In one embodiment, the present invention is embodied in a ZIP™ disk developed by Iomega Corporation, Roy, Utah. Many other disk cartridges can be used without departing from the principles of the present invention.

FIG. 5 shows an exemplary cartridge 510 for calibrating a drag disk drive unit in accordance with the present invention. The cartridge 510 comprises an upper shell 522, a lower shell 524, a conductive, non magnetic disk 530 and at least one magnet 535, whereby said magnet creates a magnetic field.

The conductive, non-magnetic disk 530 floats between the upper shell 522 and lower shell 524 and preferably has a centrally located hub 540. These characteristics allow the spindle of a disk drive motor circuit (not shown) to engage and spin the disk. While the disk 530 is spinning through a magnetic field created by the at least one magnet 535, eddy currents are created. The eddy currents act as a resistance to the disk drive motor (not shown). Therefore, the motor draws more current in order to maintain the same spinning rate. As described below, the current drawn by the motor while spinning the conductive, non magnetic disk 530 through the magnetic field is used to determine the amount of fuzzed liner in a disk cartridge.

In the preferred embodiment, the disks have at least one aperture 550. As shown, the disk has multiple apertures 550. The aperture(s) reduces the disk's weight. A lighter disk is preferred because the disk drive motor can more easily spin a lighter disk because it is a lighter mass.

In the preferred embodiment, the magnets 535 are placed in the cartridge 510 with the non-magnetic, conductive disk 530. However, it is contemplated that the magnets 535 can be placed elsewhere, such as, for example, in the calibration disk drive unit.

Also shown in FIG. 5 are slots 535a in the lower shell 524 of the cartridge 510. The slots 535a secure the magnets 535 within the cartridge 510. The slots 535a can also be on the upper shell without departing from the principles of the invention. Also, others ways to secure the magnets are contemplated such as, for example, braces or the like without departing from the principles of the invention.

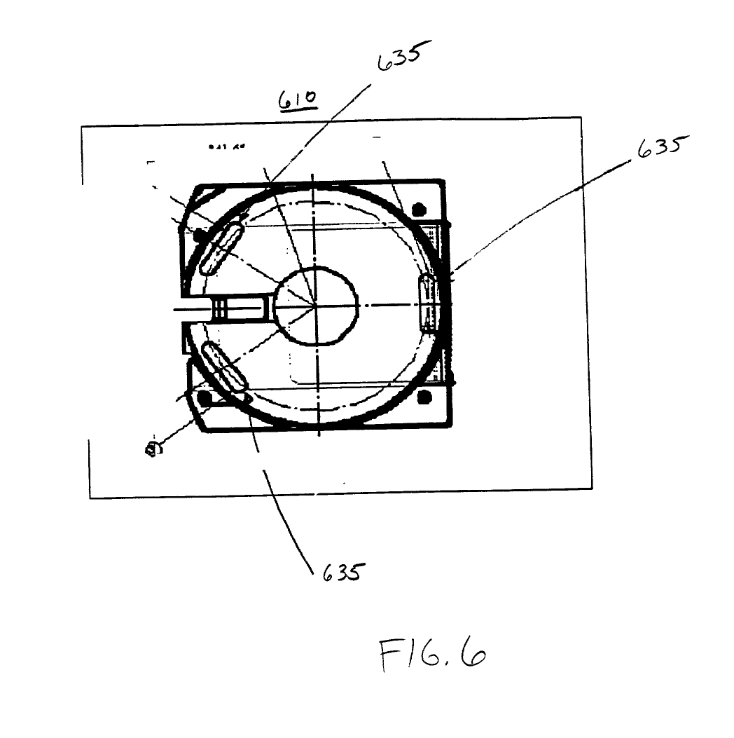

FIG. 6 shows a top view of the calibration cartridge 610 according to the principles of the invention. FIG. 6 more clearly shows the location of the magnets 635 according to one embodiment of the present invention. In one embodiment, as shown, there are three magnets 635 positioned perpendicular to the radius of the conductive, non magnetic disk. However, the number and locations of the magnets can vary without departing from the principles of the invention.

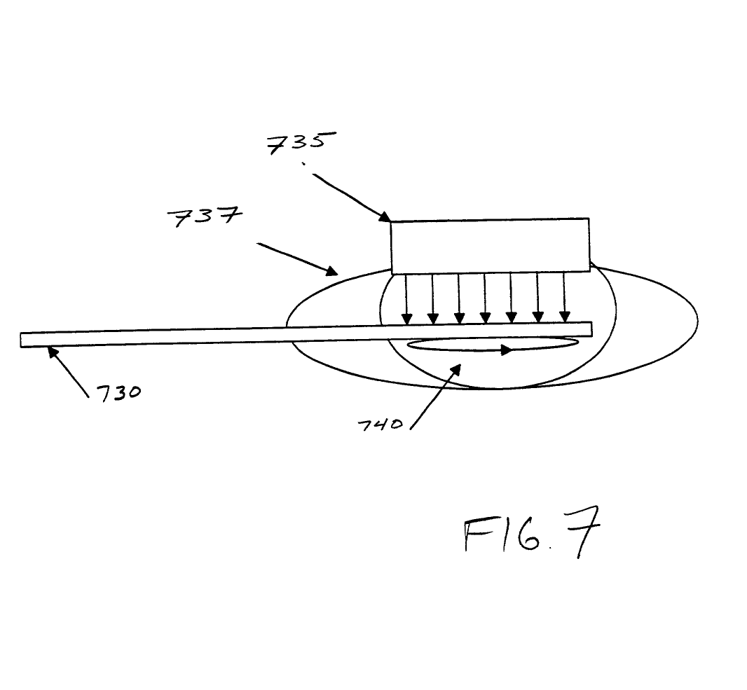

FIG. 7 is a diagram that is used to illustrate how the invention utilizes eddy currents to calibrate a drag drive. FIG. 7 shows a non-magnetic, conductive disk 730 placed in a magnetic field 737 created by a magnet 735. The non-magnetic, conductive disk 730 is spun in the disk drive unit (not shown) through the magnetic field 737. As the disk 730 is spinning through the magnetic field 737, eddy currents 740 develop. The eddy currents 740 create a torque resistance to the spinning disk 730. The torque resistance causes the disk drive motor (not shown) to draw more power to spin the disk 730 at the same rate. This rate, generally, is the rate used for read/write purposes. It is this increase in power consumption that contributes to the calibration of a drag measuring disk drive.

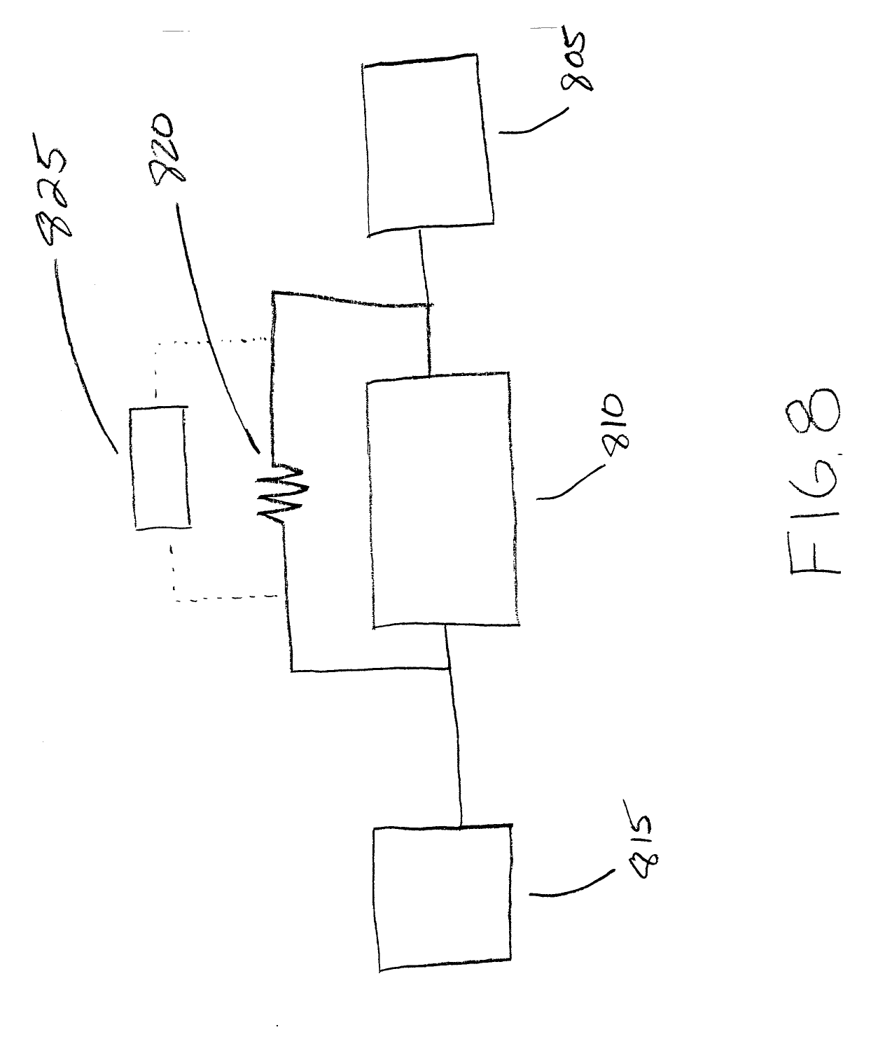

FIG. 8 is a diagram illustrating an apparatus for calibrating a drag measuring disk drive. FIG. 8 shows a power supply 805 that powers a motor 810. The motor 810 drives a load. In one embodiment, the load is a spindle (not shown) that is capable of spinning a conductive, non magnetic disk (not shown). A resistor 820 is connected in parallel with the motor 810 and serves as a sense resistor that is used to measure the current drawn by the motor 810. A device 825 is used to measure the voltage across the resistor 820. In one embodiment, the device 825 is a voltmeter that can measure the voltage drop across the resistor. The current can then be determined using Ohm's law.

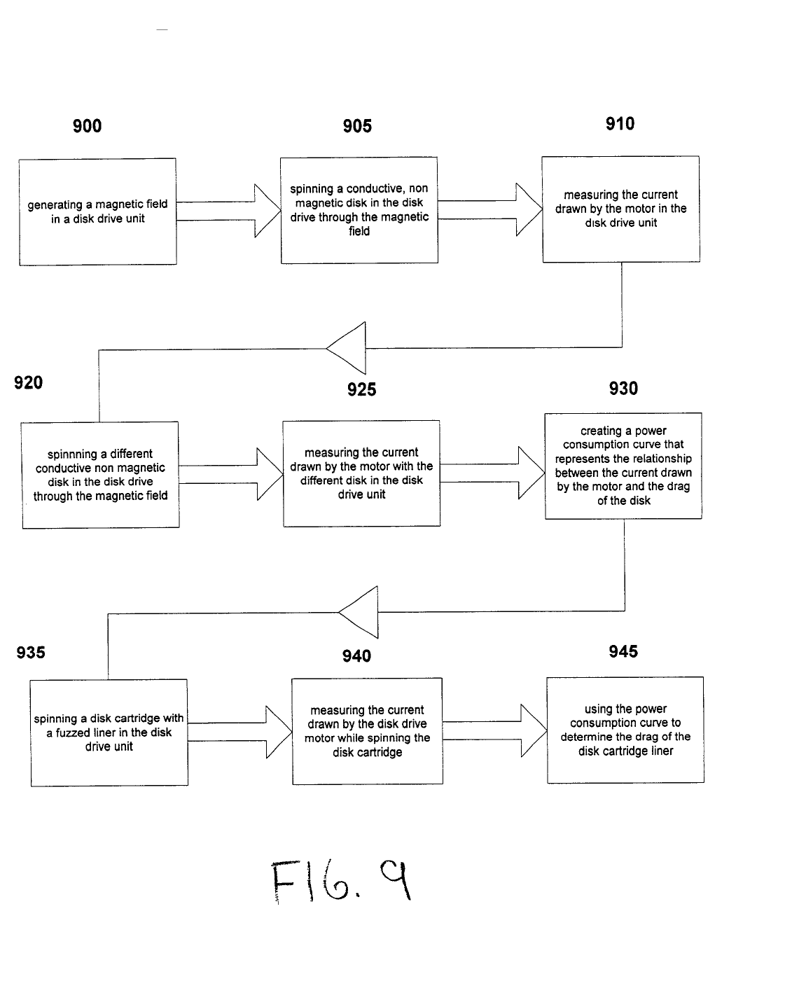

FIG. 9 is a flowchart describing an exemplary method of using an apparatus for calibrating drag measuring disk drives and for determining the fluffed region of a disk cartridge according to the invention. In use, the drag cartridge is inserted into a drag drive. The drag drive can be any typical disk drive unit that accepts removable magnetic media modified in accordance with the invention. As stated above, the preferred embodiment is a Zip™ disk drive unit. In one embodiment, a disk drive unit is used that does not have read/write heads. The absence of read/write heads allows the drag cartridge to spin free and prevents accidental damage that may occur due to obstruction from the heads.

A magnetic field is generated in the drag drive unit at step 900. A conductive, nonmagnetic disk with a known torque value is then spun in the disk drive unit through the magnetic field at step 905. The current or power that the motor is drawing is measured while spinning the disk at step 910.

In one embodiment, the voltage is measured using a sense resistor that is placed in parallel with the disk drive motor. While spinning the drag cartridge, the voltage drop across the resistor can be measured using a voltmeter. Ohm's law can then be used to determine the amount of current. Other measuring techniques can also be used can be used without departing from the principles of the present invention.

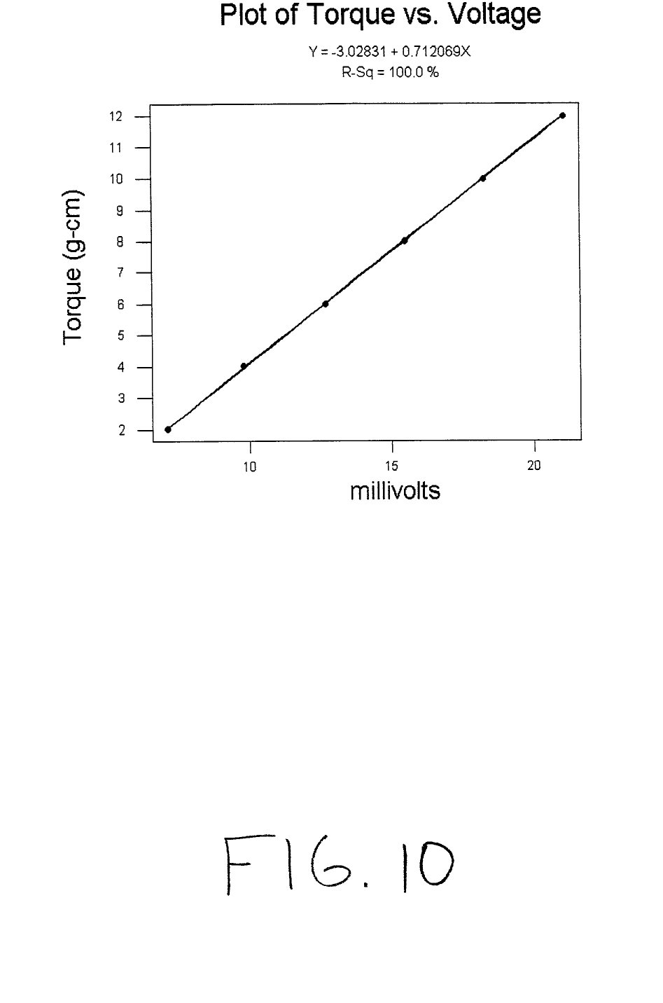

Different drag cartridges can be used to create a power consumption graph. In this manner, different calibration cartridges, which have different drag values, are spun in the calibration drive unit at step 920 and the current drawn is measured at step 925. The different cartridges have different drag values and therefore the disk makes the drive motor draw a different amount of power in order to maintain the same spinning rate. At step 930, a power consumption curve can be graphed that plots the torque of the motor versus the voltage drop across the resistor while spinning different disks. The graph represents the amount of drag or torque of the cartridge in relation to the power drawn by the drive motor for each calibration cartridge. Refer to FIG. 10 for an exemplary power consumption curve.

Then, when a disk with a fuzzed liner is spun in the calibration drive unit at step 935, the amount of current the drive motor draws is measured using a sense resistor at step 940. The drag of the fuzzed liner can be determined by regression using the power consumption curve from above at step 945. The fluffing process can then be adjusted as to fluff the correct amount of fibers to obtain the desired drag readings.

FIG. 10 is an exemplary power consumption curve. The power consumption curve plots torque versus volts. The voltage represents the voltage drop across the sensing resistor and the torque represents the measure of angular force that produces rotational motion. In this case, as the voltage drop across the resistor increases, the torque on the motor increases as well.

As stated above, after a power consumption curve is created, a disk cartridge can then be used in the drag measuring disk drive unit. While the disk drive is spinning the disk, the voltage (V_{τ}) across the resistor can be measured. When V_{τ} is compared to the power consumption curve, the drag can be derived from the torque.

As the foregoing illustrates, the present invention is directed to general motor calibration and a torque calibration cartridge. It is understood that changes may be made to the embodiments described above without departing from the broad inventive concepts thereof. For example the calibration drive unit could be one other than the ZIP™ drive made by Iomega Corporation, Roy, Utah. Accordingly, the present invention is not limited to the particular embodiments disclosed, but is intended to cover all modifications that are within the spirit and scope of the invention, as defined by the appended claims.

What is claimed is:

1. Apparatus for calibrating a drag measuring disk drive comprising:
a motor for driving a load;
a resistor connected in parallel with said motor;
a current measuring device connected to said resistor for determining the amount of current drawn by said motor;
a conductive, non magnetic disk; and
at least one magnet placed substantially planar to said non magnetic disk wherein said disk is adapted to spin through a magnetic field produced by said at least one magnet.

2. The apparatus of claim 1, wherein said resistor is a sense resistor connected in parallel with said motor.

3. The apparatus of claim 1, wherein said load is a spindle capable of holding a disk.

4. The apparatus of claim 1 further comprising a plurality of said magnets.

5. The apparatus of claim 1, wherein said conductive, non magnetic disk has at least one aperture.

6. The apparatus of claim 1, wherein said drag measuring drive is a disk drive without read/write heads.

7. A cartridge for calibrating a drag disk drive unit used in the process of determining the amount of fuzzed liner on a disk cartridge, comprising:
an upper shell;
a lower shell;
a conductive, non-magnetic disk; and
at least one magnet substantially planar to said conductive, non magnetic disk whereby said magnet creates a magnetic field.

8. The cartridge recited in claim 7, wherein said disk has at least one aperture.

9. The cartridge recited in claim 7, wherein one of said upper shell and said lower shell has a slot that secures said at least one magnet.

10. An apparatus for measuring current comprising:
a motor for driving a load;
a resistor connected in parallel with said motor; and
a current measuring device connected to said resistor for determining the amount of current drawn by said motor.

11. The apparatus of claim 10, wherein said load is a spindle capable of holding a disk.

12. A method of calibrating a drag measuring disk drive, the method comprising:
generating a magnetic field in said disk drive;
spinning a conductive, non magnetic disk in said disk drive through said magnetic field; and
measuring current being drawn by a motor in said drive unit.

13. The method of claim 12, wherein the method further comprises:
separately spinning a second conductive, non magnetic disk in said disk drive;
measuring the current being drawn by said motor spinning said second disk; and
determining a relationship between the drag of each disk and the current drawn by each disk.

14. The method of claim 13, wherein the method further comprises:
creating a power consumption curve wherein said curve shows the relationship between the drag of each disk and said current drawn by said motor.

15. The method described in claim 12, wherein the method further comprises:
measuring the current using a sense resistor.
